(19) United States
(12) Patent Application Publication
(10) Pub. No.: US 2021/0326575 A1
(43) Pub. Date: Oct. 21, 2021

(54) FACE RECOGNITION DEVICE

(71) Applicant: SHENZHEN SENSETIME TECHNOLOGY CO., LTD., Shenzhen (CN)

(72) Inventors: Xu WANG, Shenzhen (CN); Genzai WANG, Shenzhen (CN); Wanzhi LI, Shenzhen (CN)

(73) Assignee: SHENZHEN SENSETIME TECHNOLOGY CO., LTD., Shenzhen (CN)

(21) Appl. No.: 17/362,789

(22) Filed: Jun. 29, 2021

Related U.S. Application Data
(63) Continuation of application No. PCT/CN2020/096872, filed on Jun. 18, 2020.

(30) Foreign Application Priority Data
Jan. 22, 2020 (CN) 202020142261.8

(51) Int. Cl. G06K 9/00; G06K 9/62; G06K 7/10

(52) U.S. Cl. CPC G06K 9/00255; G06K 9/00771; G06K 7/10366; G06K 9/00288; G06K 9/6215

(57) ABSTRACT

A face recognition device includes a screen component, a middle frame and a radio frequency antenna. The screen component is installed on the middle frame, the radio frequency antenna is disposed between the middle frame and the screen component, and the screen component is provided with a clear zone, so that the radio frequency antenna radiates electromagnetic waves outward through the clear zone of the screen component. Since the radio frequency antenna is disposed between the middle frame and the screen component and the screen component is provided with the clear zone, the radio frequency antenna can radiate electromagnetic waves outward through the clear zone on the screen component, so as to establish a communication with an electronic tag.

### CROSS-REFERENCE TO RELATED APPLICATIONS

This is a continuation of International Patent Application No. PCT/CN2020/096872 filed on Jun. 18, 2020, which claims priority to Chinese Patent Application No. 202020142261.8 filed on Jan. 22, 2020. The disclosures of these applications are hereby incorporated by reference in their entirety.

### BACKGROUND

At present, a traditional face recognition apparatus is mainly made of a metal material. Since the metal material has a shielding effect on an antenna, the face recognition apparatus usually performs face recognition by obtaining a face image, and only has a face recognition function.

Generally, in order to realize a card swiping function in the face recognition apparatus, an independent region is usually designed separately, a Radio Frequency Identification (RFID) antenna is disposed in the independent region, and the card swiping function of the face recognition apparatus is realized through the RFID antenna. However, in the process of realizing the card swiping function, an independent region needs to be added, the added independent region will increase the overall volume of the face recognition apparatus, and thus, the face recognition apparatus that realizes the card swiping function has a large overall volume.

### SUMMARY

The embodiments of the disclosure relate to the technical field of face recognition and provide a face recognition device.

The face recognition device provided by the embodiments of the disclosure includes a screen component, a middle frame and a radio frequency antenna. The screen component is installed on the middle frame, the radio frequency antenna is disposed between the middle frame and the screen component, and the screen component is provided with a clear zone through which the radio frequency antenna radiates electromagnetic waves outward.

Through the embodiments of the disclosure, since the radio frequency antenna is disposed between the middle frame and the screen component and the screen component is provided with the clear zone, the radio frequency antenna may radiate electromagnetic waves outward through the clear zone on the screen component, so as to establish a communication with an electronic tag. Therefore, the face recognition device according to the embodiments of the disclosure may realize a card swiping function without increasing the volume of the face recognition device.

In some embodiments of the disclosure, the screen component includes a metal plate, a screen and a cover plate which are stacked, the metal plate is connected to the middle frame, the metal plate is provided with a penetrated through hole, the through hole is configured to form the clear zone, and the radio frequency antenna is disposed on the middle frame and is at least partially accommodated in the through hole.

By forming the through hole on the metal plate to form the clear zone and enabling the RFID antenna to be at least partially accommodated in the through hole, on the one hand, the RFID antenna is located in the clear zone, so that electromagnetic waves may be radiated outward; and on the other hand, the thickness size of the face recognition device in a direction perpendicular to the screen is hardly increased, so that the volume of the face recognition device is hardly increased.

In some embodiments of the disclosure, there is a spacing distance between the peripheral side walls of the through hole and the corresponding peripheral side walls of the radio frequency antenna, that is, in the length and width directions of the center plate, the size of the through hole is greater than the size of the radio frequency antenna, and the radio frequency antenna is not in contact with the metal plate. In this way, the through hole may form a sufficient clear zone to avoid the shielding of electromagnetic wave signals, so as to meet the communication requirements of the radio frequency antenna and the electronic tag.

In some embodiments of the disclosure, the middle frame includes a plurality of side frames and a center plate connected to the plurality of side frames, the plurality of side frames surround the screen, the radio frequency antenna is disposed on the center plate, and a wave absorbing material is disposed between the radio frequency antenna and the center plate. Since the center plate is made of metal materials, the wave absorbing material is disposed between the radio frequency antenna and the center plate, which may improve the radiation property of the radio frequency antenna and increase the signal strength of the radiated electromagnetic waves.

In some embodiments of the disclosure, the wave absorbing material is ferrite, and the ferrite has the advantages of large resistivity, low eddy current loss and the like, and is widely applied.

In some embodiments of the disclosure, the center plate is provided with a groove, the radio frequency antenna is partially accommodated in the groove, and one surface of the metal plate is connected to one surface of the center plate, so that the groove may clamp the radio frequency antenna to achieve a fixing effect. In addition, since the radio frequency antenna is partially accommodated in the groove and partially accommodated in the through hole and the metal plate is in surface contact with the center plate, compared with a face recognition device without a radio frequency antenna, after the radio frequency antenna is added in this embodiment, the overall thickness of the face recognition device is not increased.

In some embodiments of the disclosure, another surface of the metal plate is connected to one surface of the screen, one surface of the radio frequency antenna is connected to one surface of the screen through the through hole, one surface of the radio frequency antenna is opposite to the center plate, and one surface of the metal plate is opposite to another surface of the metal plate. In a direction perpendicular to a display surface of the screen, the thickness of the radio frequency antenna is equal to the sum of the depths of the groove and the through hole (in an embodiment without the groove, the depth of the groove is 0), so that the overall thickness of the face recognition device is not increased, and the thin appearance of the face recognition device is maintained. In addition, the radio frequency antenna is in surface contact with the screen, so that the radio frequency antenna is closer to a user (the radio frequency antenna is closer to the surface of the cover plate facing away from the screen), the strength of the electromagnetic waves on the user side is stronger, and the face recognition device and the electronic tag may communicate more sensitively.

In some embodiments of the disclosure, the radio frequency antenna includes a main part, an extension part and a connecting end which are connected sequentially, the center plate is provided with a penetrated connecting hole, the main part is disposed on one surface of the center plate, the extension part has a bent structure, the bent structure extends to another surface of the center plate through the connecting hole, the connecting end is configured to be connected to a radio frequency identification chip, one surface of the center plate is facing the metal plate, and one surface of the center plate is opposite to another surface of the center plate. The extension part extends to another surface of the center plate to be connected to an electronic device, so that there is only the main part between the facing surfaces of the center plate and the metal plate, and there are no redundant devices. Therefore, an installation structure and a connecting structure of the screen component are easily disposed.

In some embodiments of the disclosure, the radio frequency antenna is a flexible circuit board, and the flexible circuit board has the characteristics of ultra-thin structure and easy manufacture. By manufacturing the radio frequency antenna into a flexible circuit board, the thickness of the face recognition device may be reduced.

In some embodiments of the disclosure, the face recognition device further includes a camera, a processor and a memory, the screen component is further provided with a camera hole, the camera collects a user face image through the camera hole, the processor is configured to recognize the user face image, and match a recognition result with the user information stored in the memory to recognize user identity. On the basis of realizing the face recognition function, the face recognition device may also perform card swiping, so as to realize double identity authentication to improve the security.

In some embodiments of the disclosure, the face recognition device includes any one of the following: a face recognition machine, a face recognition gate integrated machine, a face recognition and identity authentication integrated machine, a building intercom and an access control machine, which may realize double identity authentication of face recognition and card swiping to obtain high security.

### BRIEF DESCRIPTION OF THE DRAWINGS

In order to more clearly illustrate the technical solutions in the implementations of the disclosure, the drawings required for the implementations will be briefly described below. It is apparent that the drawings in the following description are only some implementations of the embodiments of the disclosure. Those skilled in the art can also obtain other drawings according to these drawings without any creative work.

FIG. 1 is a schematic diagram of a three-dimensional structure of a face recognition device according to an embodiment of the disclosure.

FIG. 2 is a schematic diagram of an explosive structure of a face recognition device according to an embodiment of the disclosure.

FIG. 3 is a schematic diagram of split structures of a face recognition device according to an embodiment of the disclosure.

FIG. 4 is a schematic structural diagram in which an RFID antenna is installed on a middle frame according to an embodiment of the disclosure.

FIG. 5 is a schematic diagram of split structures of an RFID antenna and a middle frame according to an embodiment of the disclosure.

FIG. 6 is a schematic structural diagram of an RFID antenna and a screen component according to an embodiment of the disclosure.

FIG. 7 is a schematic diagram of a front structure of an RFID antenna according to an embodiment of the disclosure.

FIG. 8 is a schematic diagram of a back structure of an RFID antenna according to an embodiment of the disclosure.

### DETAILED DESCRIPTION

The technical solutions in the implementations of the disclosure will be clearly and completely described below with reference to the drawings in the implementations of the disclosure. It is apparent that the described implementations are only a part of the implementations of the disclosure, but are not all of the implementations. Based on the implementations in the disclosure, all other implementations obtained by those skilled in the art without creative efforts fall within the protection scope of the disclosure.

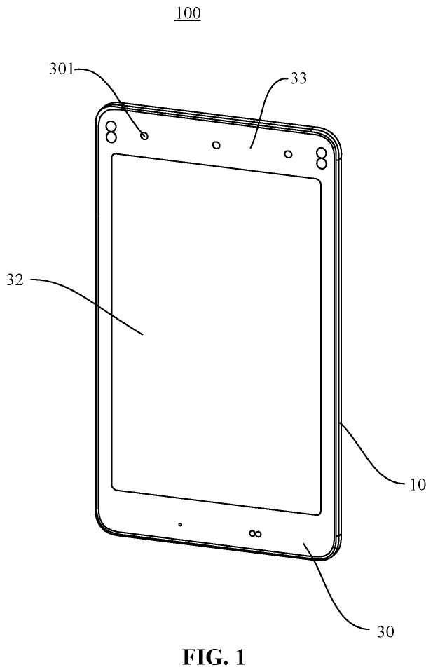

Referring to FIG. 1, the disclosure provides a face recognition device 100, including a middle frame 10 and a screen component 30. The screen component 30 is installed on the middle frame 10. The middle frame 10 is made of a metal material, and the middle frame 10 is a support framework of the entire face recognition device 100. The screen component 30 may be a Liquid Crystal Display (LCD) module or an Organic Light-Emitting Diode (OLED) module. The screen component 30 includes a screen 32 and a cover plate 33, and the cover plate 33 is disposed on the screen 32 to protect the screen 32. The cover plate 33 is made of transparent materials, such as glass or resin materials. The area of the cover plate 33 is greater than the area of the screen 32, and the region on the periphery of the screen 32 on the cover plate 33 may be coated with light-shielding ink to shield the components in the face recognition device 100, so that the face recognition device 100 has a complete appearance. The screen 32 may be an LCD screen or an OLED display screen. The screen 32 may also have a touch function, and the corresponding touch solution may be any touch screen solution. The screen component 30 may also be provided with functional holes 301, the number of the functional holes 301 is not limited, and the types of the functional holes 301 may be camera holes, a microphone hole, a light sensor hole and the like for accommodating a camera, a microphone, a light sensor and the like.

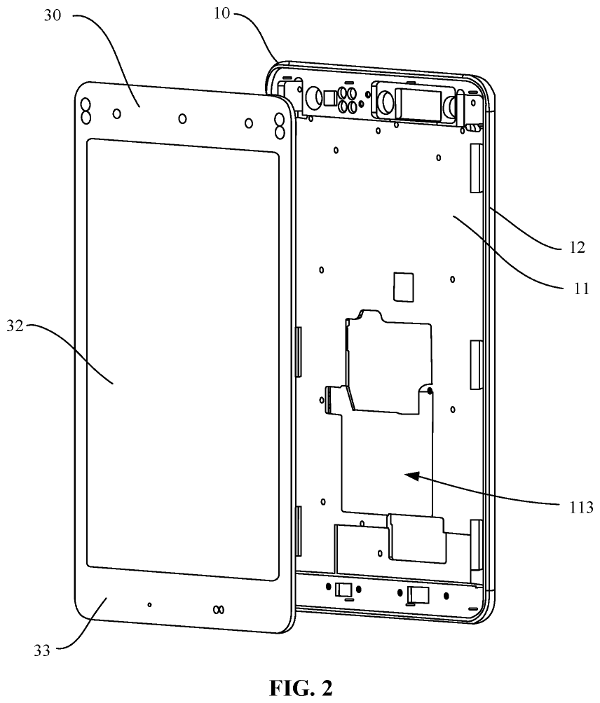

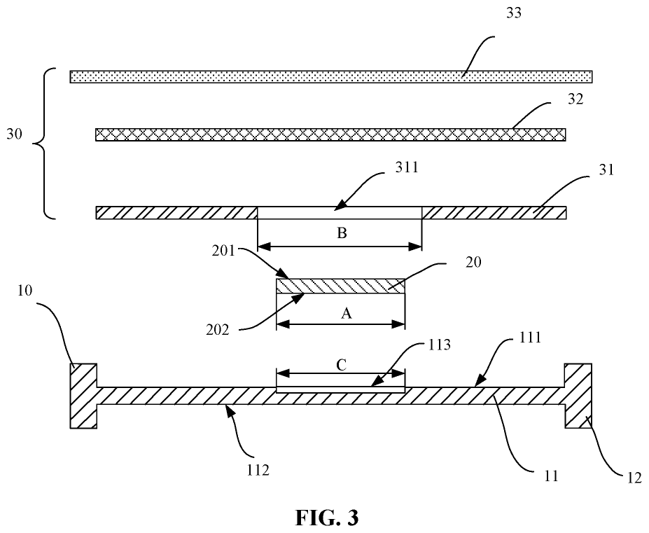

Referring to FIG. 2 and FIG. 3, the middle frame 10 includes a center plate 11 and a plurality of side frames 12, the center plate 11 and the plurality of side frames 12 are of an integrated structure, and the plurality of side frames 12 surround the center plate 11. For example, the number of the side frames 12 is four. The center plate 11 is connected to the middle parts of the plurality of side frames 12, so that the plurality of side frames 12 and the center plate 11 can surround two accommodating spaces including: an accommodating space on a front surface 111 (which is one surface of the center plate) of the center plate 11, and an accommodating space on a back surface 112 (which is another surface of the center plate) of the center plate 11. The accommodating space on the front surface 111 of the center plate 11 is configured to accommodate the screen component 30, the screen 32 in the screen component 30 is accommodated in the accommodating space on the front surface 111 of the center plate 11, and the plurality of side frames 12 surround the screen 32. The cover plate 33 is installed on the side frames 12, the cover plate 33 may be flush with the side frames 12, and the cover plate 33 may also partially protrude from the side frames 12. The accommodating space on the back surface 112 of the center plate 11 can be configured to accommodate a main board, batteries and the like, and the accommodating space on the back surface 112 of the center plate 11 can be closed by disposing a back cover, thereby forming a complete face recognition device.

The face recognition device 100 further includes a radio frequency antenna, such as a Near Field Communication (NFC) antenna, an RFID antenna and a transceiving antenna. Here, an RFID antenna 20 is taken as an example to illustrate the face recognition device 100 in the embodiments of the disclosure. The RFID antenna 20 is disposed between the middle frame 10 and the screen component 30, and the RFID antenna 20 is disposed between the center plate 11 and the screen component 30. The screen component 30 is provided with a clear zone, and the position of the RFID antenna 20 corresponds to the clear zone, so that the RFID antenna 20 radiates electromagnetic waves outward through the clear zone of the screen component 30.

The RFID antenna 20 is a reader-writer of an electronic tag, the RFID antenna can transmit and receive electromagnetic waves, and the frequency of the electromagnetic waves may be 13.56 MHz. When the electronic tag enters an effective working region of the RFID antenna, an induced current is generated to obtain energy to activate the electronic tag, so that the electronic tag transmits its own coded information through a built-in antenna; a receiving antenna of the reader-writer receives the coded information transmitted from the electronic tag, the coded information is transmitted as a modulation signal to a reader-writer signal processing module through a modulator of the antenna so as to be demodulated and decoded, and then, the effective information corresponding to the coded information is transmitted to a background host system for relevant processing; and the host system recognizes the identity of the electronic tag according to logical operations, makes corresponding processing and control for different settings, and finally sends a signal to control the reader-writer to complete different reading and writing operations. The electronic tag may be employee cards, ID cards, bus cards, recharge cards and the like with circuits and coils inside. The contact between the electronic tag and the RFID antenna 20 is non-contact, that is, the communication between the electronic tag and the RFID antenna 20 is realized in a wireless manner.

Since the RFID antenna 20 is disposed between the middle frame 10 and the screen component 30 and the screen component 30 is provided with the clear zone, the RFID antenna 20 can radiate electromagnetic waves outward through the clear zone on the screen component 30, so as to establish a communication with an electronic tag. Therefore, the face recognition device 100 provided by the embodiments of the disclosure realizes an RFID card swiping function without adding an independent region, the volume of the face recognition device can be kept unchanged, and the appearance is coordinated and unified.

Generally, a face recognition device with an RFID card swiping function needs to be provided with an independent component for installing an RFID antenna, which increases the volume and weight of the face recognition device. The face recognition device 100 provided by the embodiments of the disclosure has no need of increasing the device volume and has no need of disposing independent components, so that the weight can be reduced by 10% to 20%.

When the RFID antenna 20 communicates with an electronic tag through the screen component 30, the electronic tag can be recognized by the RFID antenna 20 by making the electronic tag close to the screen component 30, thereby reading the information of the electronic tag. In some embodiments of the disclosure, the face recognition device 100 can also write information into the electronic tag.

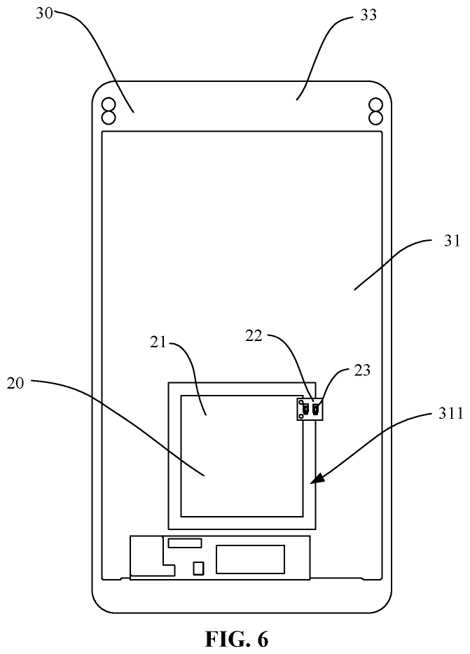

In some embodiments of the disclosure, referring to FIG. 3 and FIG. 6, the screen component 30 includes a metal plate 31. The metal plate 31 is configured to enhance the structural strength of the screen component 30 to protect the screen 32. The metal plate 31, the screen 32 and the cover plate 33 are stacked. The metal plate 31 is connected to the middle frame 10. The metal plate 31 is provided with a penetrated through hole 311. The through hole 311 is configured to form a clear zone. The RFID antenna 20 is disposed on the middle frame 10 and is at least partially accommodated in the through hole 311.

It is to be noted that metal materials have a shielding effect on electromagnetic waves, and non-metal materials have no shielding effect on electromagnetic waves. The metal plate 31 is made of metal materials, such as steel and aluminum, having a shielding effect on electromagnetic waves. The screen 32 may be an LCD screen, including an array substrate, a color film substrate and a liquid crystal layer. The array substrate and the color film substrate are provided with electrode layers made of metal materials. The liquid crystal layer is a non-metal. The electrode layer is substantially in a mesh structure, and the middle part of the electrode layer is hollowed out. Although the electrode layer has a certain shielding effect on electromagnetic waves, the electromagnetic waves can be radiated through the hollowed-out position. When the screen 32 is an OLED, similar to the LCD screen, the OLED is also an electrode layer which is substantially in a mesh structure and is made of metal materials, so that the electromagnetic waves can also be radiated through the hollowed-out position. The cover plate 33 is made of non-metal materials which can not shield electromagnetic waves.

In the embodiments of the disclosure, by forming the through hole 311 on the metal plate 31 to form the clear zone and enabling the RFID antenna 20 to be at least partially accommodated in the through hole 311, on the one hand, the RFID antenna 20 is located in the clear zone, so that electromagnetic waves can be radiated outward; and on the other hand, the RFID antenna 20 is located in the clear zone, which hardly increases the thickness size of the face recognition device 100 in a direction perpendicular to the screen 32, so that the volume of the face recognition device 100 can not be increased.

The size of the through hole 311 may be 50 mm×50 mm to 80 mm×80 mm, which is not limited in the embodiments of the disclosure. The embodiments of the disclosure do not limit the value of the spacing distance between the RFID antenna 20 and the inner wall of the through hole 311 formed on the metal plate 31 as long as there is a sufficient clear zone to meet the radiation requirements of electromagnetic waves.

In some embodiments of the disclosure, the metal plate 31 can be replaced with other non-metal plates. In this way, on the basis of improving the structural strength of the screen component 30, the non-metal material of the non-metal plate has no shielding effect on electromagnetic waves, and a clear zone can also be formed without forming a through hole on the non-metal plate.

In some embodiments of the disclosure, referring to FIG. 3 and FIG. 6, there is a spacing distance between the peripheral side walls of the metal plate 31 surrounding the through hole 311 and the corresponding peripheral side walls of the RFID antenna 20. That is, in the length and width directions of the center plate 11, the size of the through hole 311 is greater than the size of the RFID antenna 20, and the RFID antenna 20 is not in contact with the metal plate 31. As shown in FIG. 3, in the width direction of the center plate 11, the width of the through hole 311 is B, and the width of the RFID antenna 20 is A, wherein A<B. In this way, the through hole 311 can form a sufficient clear zone to effectively avoid the shielding of electromagnetic wave signals, so as to meet the communication requirements of the RFID antenna 20 and the electronic tag.

In some embodiments of the disclosure, a wave absorbing material is disposed between the RFID antenna 20 and the center plate 11. The wave absorbing material refers to a type of material that reduces the interference of electromagnetic waves by absorbing or greatly weakening the electromagnetic wave energy projected on the surface of the wave absorbing material. Since the center plate 11 is made of metal materials, the wave absorbing material is disposed between the RFID antenna 20 and the center plate 11, which can improve the radiation property of the RFID antenna 20 and increase the signal strength of the radiated electromagnetic waves. The wave absorbing material can be disposed on the RFID antenna 20 first, and then, the RFID antenna 20 provided with the wave absorbing material is installed on the center plate 11. Or, the wave absorbing material can be disposed on the center plate 11 first, and then, the RFID antenna 20 is installed on the wave absorbing material disposed on the center plate 11.

Exemplarily, the wave absorbing material is ferrite. Here, ferrite is also called a magnetic ceramic, which refers to a composite oxide magnetic material composed of iron ions, oxygen ions and other metal ions, and there are a few magnetic oxides that do not contain iron. According to the application division, the ferrite can be divided into soft magnetic, hard magnetic, gyromagnetic, moment magnetic and piezomagnetic types. The ferrite has the advantages of large resistivity, low eddy current loss and the like, and is widely applied.

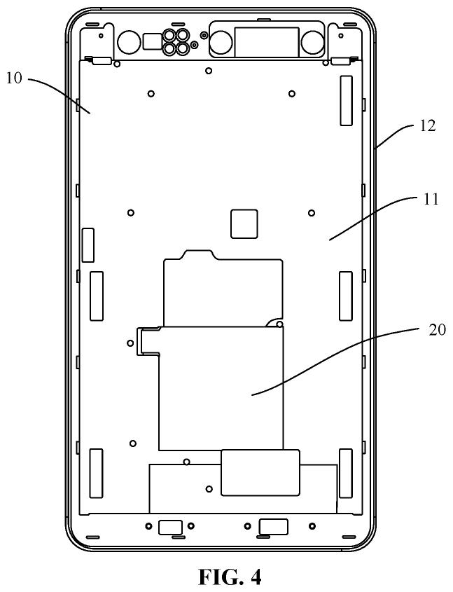

In some embodiments of the disclosure, referring to FIG. 3 to FIG. 5, the center plate 11 is provided with a groove 113, and the RFID antenna 20 is partially accommodated in the groove 113. The metal plate 31 is in surface contact with the center plate 11, that is, one surface of the metal plate 31 is connected to one surface 111 of the center plate 11. The shape and size of the groove 113 may be the same as those of the RFID antenna 20. As shown in FIG. 3, in the width direction of the center plate 11, the width of the groove 113 is C, and the width of the RFID antenna 20 is A, wherein A=C. The RFID antenna 20 is accommodated in the groove 113, the peripheral side walls of the RFID antenna 20 are connected to the side walls of the groove 113 of the center plate 11, the surface 202 of the RFID antenna 20 facing away from the screen 32 (that is, the lower surface, another surface of the RFID antenna 20) is connected to the bottom wall of the groove 113, so that the groove 113 can be locked with the RFID antenna 20 to achieve a fixing effect. In addition, since the RFID antenna 20 is partially accommodated in the groove 113 and partially accommodated in the through hole 311 and the metal plate 31 is in surface contact with the center plate 11, compared with a face recognition device without an RFID antenna 20, after the RFID antenna 20 is added in this embodiment, the overall thickness of the face recognition device 100 is not increased.

In some embodiments of the disclosure, referring to FIG. 3, the metal plate 31 is in surface contact with the screen 32, that is, another surface of the metal plate 31 is connected to one surface of the screen 32. The surface 201 of the RFID antenna 20 facing away from the center plate 11 (that is, the upper surface) is in surface contact with the screen 32, that is, one surface 201 of the RFID antenna 20 is connected to one surface of the screen 32 through the through hole 311. One surface 201 of the RFID antenna 20 is opposite to the center plate 11, one surface of the metal plate 31 is opposite to another surface of the metal plate 31, and another surface 202 of the RFID antenna 20 is opposite to one surface 201 of the RFID antenna 20. Thus, in a direction perpendicular to a display surface of the screen 32, the thickness of the RFID antenna 20 is equal to the sum of the depths of the groove 113 and the through hole 311 (in an embodiment without the groove 113, the depth of the groove 113 is 0), the overall thickness of the face recognition device 100 is not increased, and the thin appearance of the face recognition device 100 can be maintained. In addition, the RFID antenna 20 is in surface contact with the screen 32, so that the RFID antenna 20 is closer to a user (the RFID antenna 20 is closer to the surface of the cover plate 33 facing away from the screen 32), the strength of the detected electromagnetic waves on the user side is stronger, and the face recognition device 100 and the electronic tag can communicate more sensitively.

In some embodiments of the disclosure, the RFID antenna 20 may also have a certain spacing distance from the screen 32 instead of surface contact.

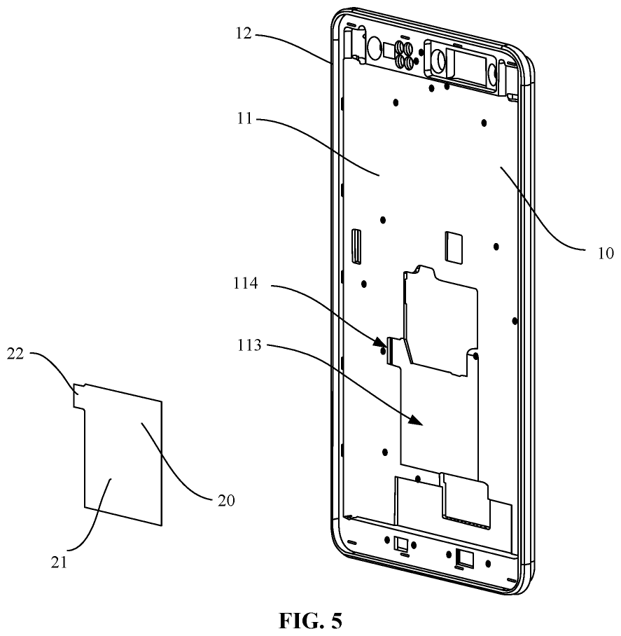

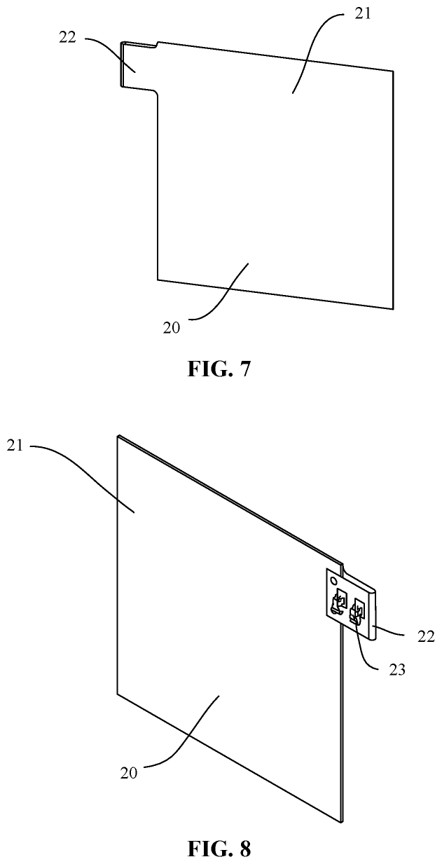

In some embodiments of the disclosure, referring to FIG. 5, FIG. 7 and FIG. 8, the RFID antenna 20 includes a main part 21, an extension part 22 and a connecting end 23 which are connected sequentially. The center plate 11 is further provided with a penetrated connecting hole 114. The main part 21 is disposed on the surface of the center plate 11 facing the metal plate 31, that is, the main part 21 is disposed on one surface of the center plate 11. The extension part 22 has a bent structure, and the bent structure extends through the connecting hole 114 to the surface of the center plate 11 facing away from the metal plate 31 (that is, another surface of the center plate). The connecting end 23 is configured to be connected to a Radio Frequency Identification chip (RFID chip, not shown in figures). The RFID chip is disposed on a main board to provide radio frequency signals or process received electromagnetic wave signals, and the RFID chip can be directly connected to the connecting end 23 or can be connected to the connecting end 23 through a structure such as a metal dome.

It can be understood that in the face recognition device 100 provided by the embodiments of the disclosure, the extension part 22 extends to another surface of the center plate 11 to be connected to the RFID chip, so that there is only the main part 21 between the facing surfaces of the center plate 11 and the metal plate 31, and there are no redundant devices. Therefore, an installation structure and a connecting structure of the screen component 30 can be easily disposed.

Exemplarily, the RFID antenna 20 is a flexible circuit board. Here, the flexible circuit board has the characteristics of ultra-thin structure, easy manufacture, and the like. By manufacturing the RFID antenna 20 into a flexible circuit board, the thickness of the face recognition device 100 can be reduced.

In the embodiments of the disclosure, the face recognition device 100 can realize a face recognition function. Here, the face recognition device 100 further includes a camera, a processor and a memory. The screen component 30 is further provided with camera holes (referring to functional holes 301 shown in FIG. 1), the camera collects a user face image through the camera hole, the processor is configured to recognize the user face image, and match a recognition result with the user information stored in the memory to recognize user identity, thereby realizing the face recognition function. Therefore, on the basis of realizing the face recognition function, the face recognition device 100 can also perform RFID card swiping, so as to realize double identity authentication to improve the security.

The face recognition device 100 according to the embodiments of the disclosure includes any one of the following: a face recognition machine, a face recognition gate integrated machine, a face recognition and identity authentication integrated machine, a building intercom, an access control machine and the like, which can realize double identity authentication of face recognition and RFID card swiping to obtain high security.

The implementations disclosed above are only some of the implementations of the disclosure. Of course, the claims of the disclosure can not be limited by this. Those skilled in the art can understand that all or part of the processes for implementing the above implementations and equivalent changes made in accordance with the claims of the disclosure still fall within the scope of the disclosure.

### INDUSTRIAL APPLICABILITY

In the embodiments of the disclosure, since the radio frequency antenna is disposed between the middle frame and the screen component and the screen component is provided with the clear zone, the radio frequency antenna can radiate electromagnetic waves outward through the clear zone on the screen component, so as to establish a communication with an electronic tag. Therefore, the face recognition device of the disclosure can realize a card swiping function without increasing the volume of the face recognition device.

What is claimed is:

1. A face recognition device, comprising a screen component, a middle frame and a radio frequency antenna, wherein the screen component is installed on the middle frame, the radio frequency antenna is disposed between the middle frame and the screen component, and the screen component is provided with a clear zone through which the radio frequency antenna is configured to radiate electromagnetic waves outward.

2. The face recognition device of claim 1, wherein the screen component comprises a metal plate, a screen and a cover plate which are stacked, the metal plate is connected to the middle frame, the metal plate is provided with a penetrated through hole for forming the clear zone, and the radio frequency antenna is disposed on the middle frame and is at least partially accommodated in the through hole.

3. The face recognition device of claim 2, wherein there is a spacing distance between the peripheral side walls of the through hole and corresponding peripheral side walls of the radio frequency antenna.

4. The face recognition device of claim 2, wherein the middle frame comprises a plurality of side frames and a center plate connected to the plurality of side frames, the plurality of side frames surround the screen, the radio frequency antenna is disposed on the center plate, and a wave absorbing material is disposed between the radio frequency antenna and the center plate.

5. The face recognition device of claim 3, wherein the middle frame comprises a plurality of side frames and a center plate connected to the plurality of side frames, the plurality of side frames surround the screen, the radio frequency antenna is disposed on the center plate, and a wave absorbing material is disposed between the radio frequency antenna and the center plate.

6. The face recognition device of claim 4, wherein the wave absorbing material is ferrite.

7. The face recognition device of claim 5, wherein the wave absorbing material is ferrite.

8. The face recognition device of claim 4, wherein the center plate is provided with a groove, the radio frequency antenna is partially accommodated in the groove, and one surface of the metal plate is connected to one surface of the center plate.

9. The face recognition device of claim 5, wherein the center plate is provided with a groove, the radio frequency antenna is partially accommodated in the groove, and one surface of the metal plate is connected to one surface of the center plate.

10. The face recognition device of claim 8, wherein another surface of the metal plate is connected to one surface of the screen, one surface of the radio frequency antenna is connected to one surface of the screen through the through hole, one surface of the radio frequency antenna is opposite to the center plate, and one surface of the metal plate is opposite to another surface of the metal plate.

11. The face recognition device of claim 9, wherein another surface of the metal plate is connected to one surface of the screen, one surface of the radio frequency antenna is connected to one surface of the screen through the through hole, one surface of the radio frequency antenna is opposite to the center plate, and one surface of the metal plate is opposite to another surface of the metal plate.

12. The face recognition device of claim 4, wherein the radio frequency antenna comprises a main part, an extension part and a connecting end which are connected sequentially, the center plate is further provided with a penetrated connecting hole, the main part is disposed on one surface of the center plate, the extension part has a bent structure, the bent structure extends to another surface of the center plate through the connecting hole, the connecting end is configured to be connected to a radio frequency identification chip, one surface of the center plate is facing the metal plate, and one surface of the center plate is opposite to another surface of the center plate.

13. The face recognition device of claim 5, wherein the radio frequency antenna comprises a main part, an extension part and a connecting end which are connected sequentially, the center plate is further provided with a penetrated connecting hole, the main part is disposed on one surface of the center plate, the extension part has a bent structure, the bent structure extends to another surface of the center plate through the connecting hole, the connecting end is configured to be connected to a radio frequency identification chip, one surface of the center plate is facing the metal plate, and one surface of the center plate is opposite to another surface of the center plate.

14. The face recognition device of claim 1, wherein the radio frequency antenna is a flexible circuit board.

15. The face recognition device of claim 2, wherein the radio frequency antenna is a flexible circuit board.

16. The face recognition device of claim 3, wherein the radio frequency antenna is a flexible circuit board.

17. The face recognition device of claim 1, further comprising a camera, a processor and a memory, the screen component is further provided with a camera hole, the camera collects a user face image through the camera hole, the processor is configured to recognize the user face image, and match a recognition result with the user information stored in the memory to recognize user identity.

18. The face recognition device of claim 2, further comprising a camera, a processor and a memory, the screen component is further provided with a camera hole, the camera collects a user face image through the camera hole, the processor is configured to recognize the user face image, and match a recognition result with the user information stored in the memory to recognize user identity.

19. The face recognition device of claim 3, further comprising a camera, a processor and a memory, the screen component is further provided with a camera hole, the camera collects a user face image through the camera hole, the processor is configured to recognize the user face image, and match a recognition result with the user information stored in the memory to recognize user identity.

20. The face recognition device of claim 1, wherein the radio frequency antenna is configured to radiate electromagnetic waves outward through the clear zone on the screen component to thereby establish a communication with an electronic tag without increasing a volume of the face recognition device.
